(19) United States
(12) Patent Application Publication
(10) Pub. No.: US 2011/0294087 A1
(43) Pub. Date: Dec. 1, 2011

(54) HEATING PLATE FOR HEATING A SHEET

(75) Inventor: DETLEV GERTITSCHKE, Laupheim (DE)

(73) Assignee: UHLMANN PAC-SYSTEME GMBH & CO. KG, Laupheim (DE)

(21) Appl. No.: 13/107,217

(22) Filed: May 13, 2011

(30) Foreign Application Priority Data
May 26, 2010 (EP) 10163930.0

(51) Int. Cl. F27D 5/00

(52) U.S. Cl. 432/253

(57) ABSTRACT

The heating plate for heating a sheet in a thermoforming machine prior to forming comprises a highly heat-conductive support plate having a working surface, a heating means connected to the support plate, and a wear layer formed as a replaceable wear plate, which is held magnetically to the working surface of the support plate.

### RELATED APPLICATIONS

The present patent document claims the benefit of priority to European Patent Application No. EP 10163930.0, filed May 26, 2010, and entitled “HEATING PLATE FOR HEATING A SHEET,” the entire contents of which are incorporated herein by reference.

### FIELD AND BACKGROUND

The present invention pertains to a heating plate for heating a sheet, in particular a plastic sheet.

These types of heating plates are standard components of thermoforming machines, where they are used to heat up the sheet prior to forming. A special area of application is the use of thermoforming machines for the production of blister packs in the pharmaceutical industry. To achieve highly efficient heat transfer, these heating plates are designed as contact heaters. A heating plate of this type usually consists of a heating means, a support plate of high thermal conductivity connected to the heating means, and a thermally sprayed-on wear layer, which is applied to the working surface of the support plate, i.e., the surface which faces the sheet to be heated. To ensure good heat transfer, the heating means, the support plate, and the wear layer are bonded permanently together. These sprayed-on wear layers are not gas-tight, however, and must be sealed by an additional fabrication step.

Because sheets have different adhesion behaviors, different wear layers must be used, each being provided with the type of surface structure and coating suited to the specific type of sheet to be heated, which means that, to ensure optimal production, the heating plate must be replaced when a change is made from one type of sheet to another. PVC-containing sheets, furthermore, release gas when heated to the forming temperature, and the resulting gases are damaging to the porous surfaces of the heating plates and can even lead to the destruction of the wear layer.

### BRIEF SUMMARY

It is an object of the present invention to provide a heating plate for heating a sheet which can be easily adapted to sheets of different types.

According to an aspect of the invention, the heating plate for heating a sheet in a thermoforming machine prior to forming comprises a highly heat-conductive support plate having a working surface; a heating means connected to the support plate; and a wear layer in the area of the working surface of the support plate. The wear layer is formed as a replaceable wear plate, which is held magnetically to the working surface of the support plate.

Thus, it is possible to replace the wear plate easily when a change is to be made from one type of sheet to be heated to another or when a defect is discovered. At the same time, the magnetic connection guarantees that the wear plate will be held firmly on the support plate during operation and that, because the wear plate lies directly on the support plate, heat will be transferred effectively from the support plate to the wear plate.

In a specific embodiment, the support plate comprises heat-resistant permanent magnets. This guarantees that the magnetic function will remain fully preserved during the operation of the heating plate.

The permanent magnets are preferably distributed in a regular pattern over the support plate. As a result, uniform heat transfer is achieved, the wear plate is held uniformly to the support plate, and the wear plate can be replaced easily without tools.

The permanent magnets are preferably fastened in recesses in the support plate. The permanent magnets are thus integrated into the support plate.

The recesses are preferably formed in the working surface of the support plate. As a result, the distance between the permanent magnets and the wear plate is minimized, and the magnetic force is maximized.

It is especially preferable for the permanent magnets to be flat clamping magnets, possibly with a circular base surface.

The wear plate preferably consists of ferritic stainless steel. Because of its corrosion resistance, stainless steel is an ideal base material for a corrosion-resistant and wear-resistant wear plate.

The wear plate has a thickness of 0.2-1.0 mm, and preferably of 0.5-0.8 mm. A stainless steel sheet with a thickness in this range is highly suitable for use in association with a heating plate. Even though stainless steel has relatively low thermal conductivity, this does not represent a significant problem because of the thinness of the wear plate.

The wear plate preferably comprises a surface structure with elevations measuring 5-30 μm in height on the side facing away from the working surface of the support plate. In this way, it is possible to heat highly adherent types of sheet without the danger that the sheet will stick to the wear plate.

The same purpose is served when the side of the wear plate facing away from the working surface of the support plate comprises a wear-resistant, non-stick coating.

To improve the heat transfer and to provide a lubricating layer to facilitate the replacement of the wear plate, a thermally conductive paste can be applied between the wear plate and the working surface of the support plate.

The wear plate can be replaced more easily if the wear plate comprises at least one gripping element, which, in the assembled state of the heating plate, projects laterally beyond the support plate.

To align and secure the wear plate on the support plate, the support plate comprises two projecting stop edges around the outside of its working surface. These edges are perpendicular to each other, and the wear plate is supported against them.

### BRIEF DESCRIPTION OF THE DRAWINGS

Additional features and advantages of the present invention can be derived from the following description, which refers to the drawings.

FIG. 1 is a cross-sectional view of one embodiment of the heating plate according to the invention;

FIG. 2 is a cross-sectional view of another embodiment of the heating plate according to the invention;

FIG. 3 is a cross-sectional view of another embodiment of the heating plate according to the invention;

FIG. 4 is a top view of a support plate, which is suitable for use in a heating plate according to the invention;

FIG. 5 is a perspective view of a permanent magnet, which is suitable for use in a heating plate according to the invention;

FIG. 6 is a top view of a wear plate, which is suitable for use in a heating plate according to the invention;

FIG. 7 is a top view of a different wear plate, which is suitable for use in a heating plate according to the invention; and

FIG. 8 is a partial cross-sectional view of the wear plate of FIG. 7.

### DETAILED DESCRIPTION OF SPECIFIC EMBODIMENTS

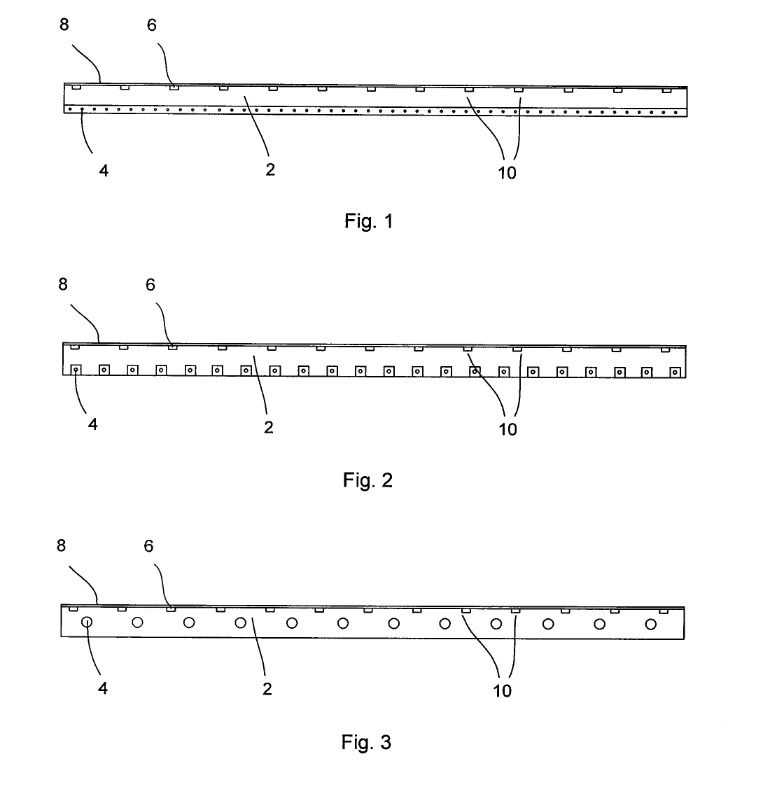

FIGS. 1-3 show three different embodiments of the heating plate according to the invention. Each of these heating plates comprises a support plate 2 of material with good thermal conductivity, preferably aluminum. A heating means 4 is used to heat the support plate 2. In the embodiment shown in FIG. 1, this means is designed as a continuous, flat heating body, which is preferably vulcanized onto the support plate 2.

It is also possible (see FIG. 2) for the heating means 4 to be made up of several heating conductors, which are laid in grooves in the support plate 2. The heating conductors are preferably flexible in this case. Finally, it is also possible for the heating means 4 (see FIG. 3) to consist of several heating cartridges, which are introduced into recesses in the support plate, or to consist of at least one induction element, which is integrated into the heating plate and heated by way of preferably stationary induction coils in the work station where the heating plate is used.

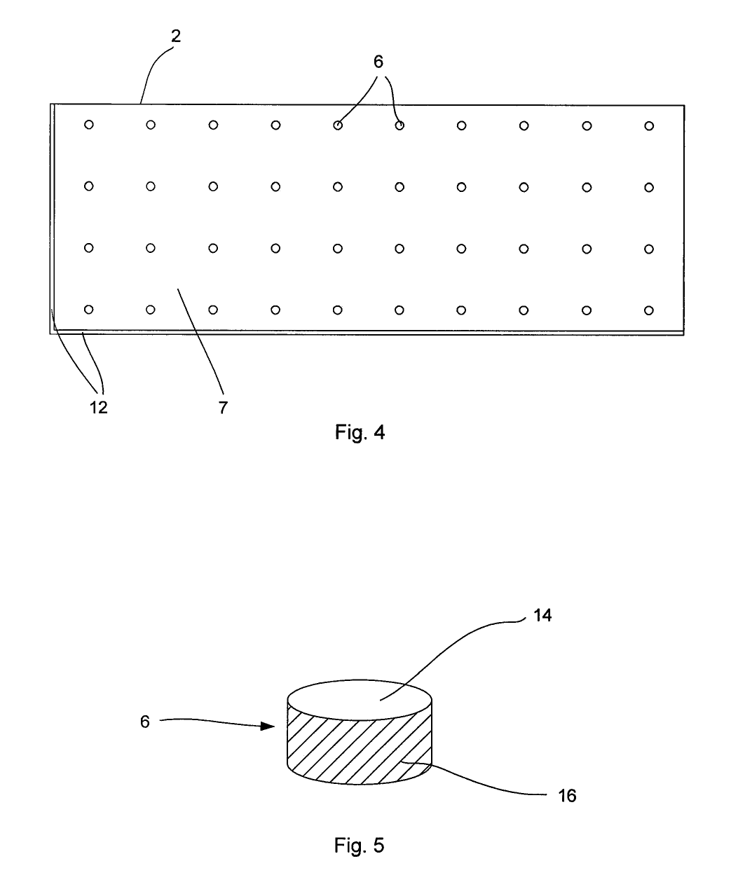

According to FIG. 4, a wear plate 8 is held magnetically to the support plate 2, namely, to the working surface 7 of the support plate 2, which, in the assembled state of the heating place, faces the sheet to be heated and represents the upper surface in each of FIGS. 1-3. The wear plate 8 preferably consists of ferritic stainless steel and has a thickness of 0.2-1.0 mm, and preferably of 0.5-0.8 mm.

There are many different ways in which the wear plate 8 can be held magnetically to the working surface 7 of the support plate 2, but it is especially preferable to use permanent magnets 6, which are introduced into recesses 10 in the support plate, where they are fastened in place. The recesses 10 are preferably formed in the working surface 7 of the support plate 2. The permanent magnets 6, furthermore, are heat-resistant and are preferably distributed in a regular pattern over the support plate 2.

So that the wear plate 8 can be oriented properly on the support plate 2, the support plate 2 comprises two projecting stop edges 12, which are located around the outside of the working surface 7 and which are perpendicular to each other. The wear plate 8 can thus be supported against these edges (see FIG. 4).

Between the wear plate 8 and the working surface 7 of the support plate 2, a thermally conductive paste can be applied to improve the heat transfer and to act as a lubricating layer to facilitate the replacement of the wear plate 8.

FIG. 5 shows an example of a usable permanent magnet 6. The permanent magnet 6 preferably has a flat design and a sturdy structure. The magnetic material 14 is preferably located in a galvanized steel cup 16 and is fastened in its assigned opening 10 in the support plate 2. It can be bonded adhesively in place by means of a silicone adhesive, for example. It is also possible to press the permanent magnets 6 into the recesses 10 or to screw them in, etc. The steel cup 16 can also be omitted.

The permanent magnets 6 are heat-resistant up to a temperature of at least 150° C. Hard ferrites, for example, are suitable as magnetic material 14.

The shorter the distance between the wear plate 8 and the permanent magnets 6, the stronger the magnetic force. Ideally, the permanent magnets 6 are flush with the working surface 7 of the support plate 2, so that the wear plate 8 rests directly on the permanent magnets 6.

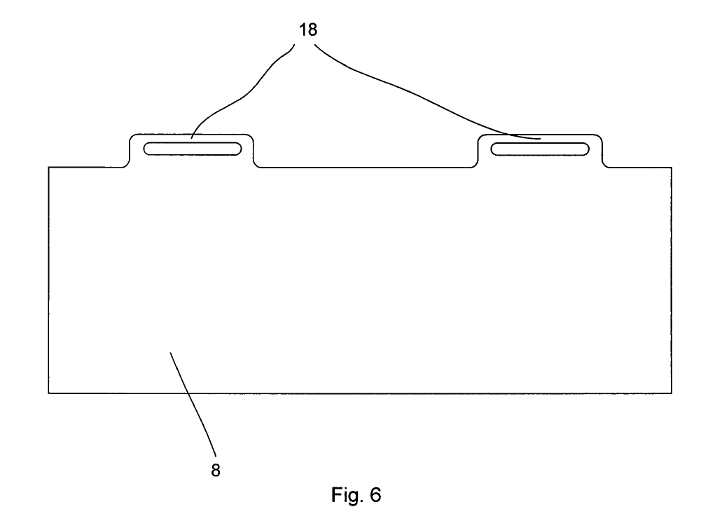

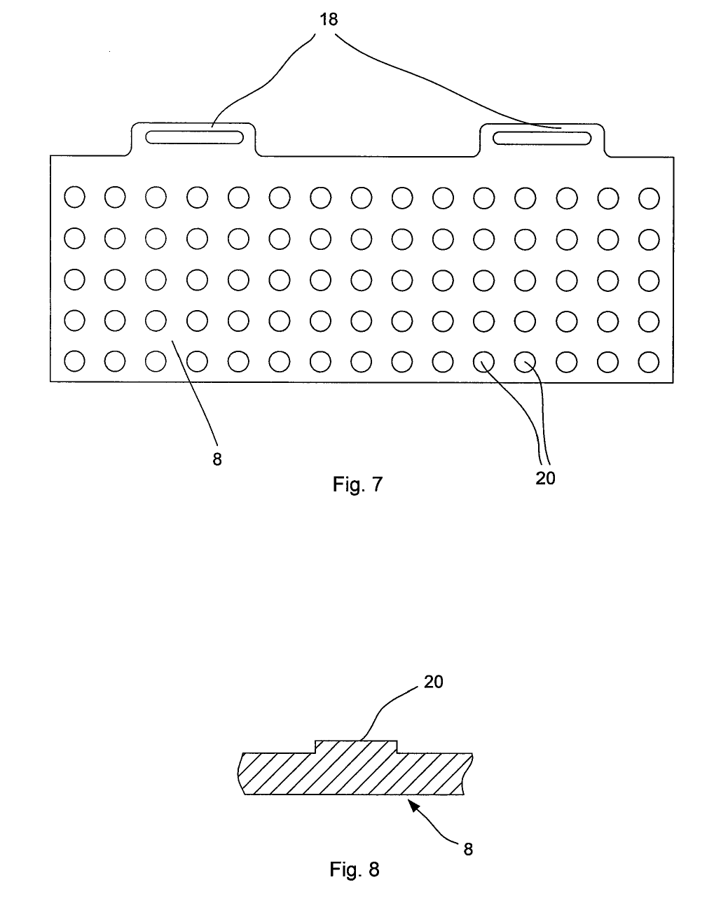

As shown in FIGS. 6 and 7, the wear plate 8 can comprise a gripping element 18, in the present case two gripping elements 18, to make it easier to replace the plate. It is also advantageous for the wear plate 8 to comprise a wear-resistant, non-stick coating on the side facing away from the working surface 7 of the support plate 2.

The wear plate 8 of FIG. 6 is basically flat in design, but it can also have a surface structure, in which the individual elevations (not shown) are 5-30 μm high. This can be combined with the previously mentioned non-stick coating. The two measures serve to prevent the sheet to be heated from sticking to the heating plate after it has been heated. At the same time there must be a sufficient number of elevations and therefore of contact zones present to ensure that sufficient heat transfer is possible from the wear plate 8 to the sheet.

The wear plate 8 of FIGS. 7 and 8 comprises projecting plateaus 20 on the side facing away from the working surface 7 of the support plate 2. These plateaus preferably have a height of a few tenths of a millimeter. In this way, especially difficult-to-form zones of the sheet can be heated more effectively. The surface structure with 5-30 μm-tall elevations and the non-stick coating are also preferably used on the plateaus 20.

With the heating plate according to the invention, it is possible to switch more quickly from one format to another, and it is easy to install individual wear plates for different types of sheets. Maintenance costs are thus reduced, and the service lives of the primary elements of the heating plate, namely, the support plate 2 and the heating means 3, are significantly increased. The new heating plate is also much easier to be cleaned.

1. A heating plate for heating a sheet in a thermoforming machine prior to forming, the heating plate comprising:
a highly heat-conductive support plate having a working surface;
a heating means connected to the support plate; and
a wear layer formed by a replaceable wear plate, which is held magnetically to the working surface of the support plate.

2. The heating plate according to claim 1, wherein the support plate comprises heat-resistant permanent magnets.

3. The heating plate according to claim 2, wherein the permanent magnets are distributed in a regular pattern over the support plate.

4. The heating plate according to claim 2, wherein the permanent magnets are fastened in recesses in the support plate.

5. The heating plate according to claim 4, wherein the recesses are formed in the working surface of the support plate.

6. The heating plate according to claim 2, wherein the permanent magnets are flat clamping magnets having a circular base surface.

7. The heating plate according to claim 1, wherein the wear plate consists of ferritic stainless steel.

8. The heating plate according to claim 1, wherein the wear plate has a thickness of 0.2-1.0 mm.

9. The heating plate according to claim 8, wherein the wear plate has a thickness of 0.5-0.8 mm.

10. The heating plate according to claim 1, wherein, on a side facing away from the working surface of the support plate, the wear plate comprises a surface structure with elevations measuring 5-30 μm in height.

11. The heating plate according to claim 1, wherein, on a side facing away from the working surface of the support plate, the wear plate comprises a wear-resistant, non-stick coating.

12. The heating plate according to claim 1, wherein a thermally conductive paste is applied between the wear plate and the working surface of the support plate.

13. The heating plate according to claim 1, wherein the wear plate comprises at least one gripping element.

14. The heating plate according to claim 1, wherein, around an outside of the working surface, the support plate comprises two projecting stop edges, which are perpendicular to each other and against which the wear plate is supported.
